(19) United States
(12) Patent Application Publication
(10) Pub. No.: US 2010/0259610 A1
(43) Pub. Date: Oct. 14, 2010

(54) Two-Dimensional Display Synced with Real World Object Movement

(75) Inventor: Barry Lee Petersen, Castle Rock, CO (US)

Correspondence Address: Law Office of Michael J. Feigin, 103 The Circle, (http://PatentLawNY.com), Passaic, NJ, 07055, US

(73) Assignee: CELSIA, LLC, San Jose, CA (US)

(21) Appl. No.: 12/420,093

(22) Filed: Apr. 8, 2009

(51) Int. Cl. H04N 7/18; G06K 9/00

(52) U.S. Cl. 348/142; 382/106; 382/195; 348/E07.085

(57) ABSTRACT

Embodiments of the disclosed technology comprise devices and methods of displaying images on a display (e.g., viewing screen) and changing the image based on a position of an object. This may be done on an advertising display, such as on a vending machine, or to enable a viewer to “look around” an object on a two-dimensional screen by moving his head. The image displayed may appear to move with the person. A first image is exhibited on the display and a position of an object, such as a person within the view of a camera is detected. When the object moves, the display changes (e.g., a second image is displayed) corresponding to the second position of the object in the viewing plane.

### FIELD OF THE DISCLOSED TECHNOLOGY

The disclosed technology relates generally to parallax viewing and, more specifically, to changing a viewing angle based on a changed position of a viewer.

### BACKGROUND OF THE DISCLOSED TECHNOLOGY

In prior art display systems, a mouse or other input device is used to control different viewpoints of a scene presented on a display device such as a screen or computer monitor. Such devices require purposeful input control on an interface to see scenes or objects from different perspectives or viewing angles. In three-dimensional displays, such as virtual reality worlds and video games, a person can use a mouse, joystick, buttons, or keyboard, for example, to navigate in three dimensions. A problem exists, however, in that using one's hands or other features to navigate dissociates an individual from the true variation of his or her body's physical location. Users must employ specific key sequences, motions or other purposeful input in an attempt to mimic a simple act of walking around an object in a three-dimensional world.

These existing types of systems do not consider the actual physical positional relationship between the person and the object in the same, or mathematically proportional (it could be distorted or non-linear), environment. In these prior art systems, position in the virtual, projected world is disconnected. In the prior art systems, the position of actual view of a person is irrelevant to what is shown on a screen. Some prior art systems have attempted to partially solve this problem by requiring complex “virtual reality” hardware that may be worn on the body, multiple displays, and the like. Changing the orientation of the head, for example, may change the viewpoint presented, but users physically move around the virtual environment with a joystick control or with button sequences while physically standing or sitting in the same place. Thus, the real and projected worlds are fundamentally disconnected in the sense of physical location.

Still further prior art systems, e.g., U.S. Pat. No. 6,407,762 to Leavy, are based on an idea of using recognition of body parts or features to display a “virtual person” in a virtual environment. For example, the head of a person may be extracted from a body and placed onto an animated figure that mimics the person's orientation in the virtual world. Again, the orientation does not relate to the location of the individual in the real world and physical relationship between that individual in reality and the virtual world space.

### SUMMARY OF THE DISCLOSED TECHNOLOGY

It is an object of the disclosed technology to allow an image displayed on a two-dimensional screen to appear to move with the viewer.

It is a further object of the disclosed technology to allow a user to feel as if he/she can see around an object or scene displayed on a display device by moving his/her position.

It is yet another object of the disclosed technology to enable a three-dimensional-like view on a two-dimensional display.

The disclosed technology allows non-invasive procedures where the real and projected worlds are connected, e.g., in sync with each other. When the person changes his physical position/location relative to objects within the environment, the projected display of the objects/environment moves in relation to the positional shift, in embodiments of the disclosed technology. The real movements and projected environment world act as one continuous environment.

A method of changing a displayed image based on a position/location of a detected object, in an embodiment of the disclosed technology, proceeds by displaying a first image on a display device, detecting with a camera first and second positions of the object in a viewing plane of said camera, and, where a distance between the first and second position is greater than a predefined threshold, a second image is displayed on the display device. The change in position may be a lateral, vertical, diagonal, or distance (backward and forward) change. Embodiments of the disclosed technology need not be limited to two images, and, in fact, successive detection and displayed images may occur for each additional position.

The object detected may be a person, and the detection may include detection of a position of a feature of a person, the feature being a silhouette, a face or an eye, for example. Each changed image may change a distance corresponding to a change in position of said object. For example, for every six inches a detected head is moved, the new image may be offset by six feet. The change in distance of the changed image may be a rotated view around a fixed point or object. For example, changing a position of an object across an entire plane of view of the camera may result in a 180 or even 360 degree rotation around the fixed point or object shown in the images. The images may be used for advertising purposes.

In a further method of changing a displayed image, a first image is displayed and then a first and second position of an object in a viewing plane are determined. For example, this may entail detecting a change in position along the x-axis (horizontal movement of the detected object), y-axis (vertical movement of the detected object), or z-axis (the object becomes closer or further to the camera). A combination thereof may also be determined, such as a change along the x and z axes. When the first and second positions are above a threshold, the distance moved between the first and second position is translated into a viewpoint change and a second image is displayed corresponding to this viewpoint change. The viewpoint change, that is, the displayed image, may be translated, zoomed, rotated around a point, or any combination thereof, with respect to the first image shown. This process may be repeated with successive images.

A device of the disclosed technology has a display device (e.g., computer monitor, neon lights, etc.) outputting a displayed image, a camera inputting data in a plane of view of the camera, a processor determining a location of an object in the plane of view, and, upon the determined location of the object changing position greater than a threshold, the displayed image on the display device is changed. A new viewpoint may be determined based on the change in position of the object (translated or zoomed position) and result in any one of a translated, zoomed, rotated, or other view. Combining a change in position on the x, y, and z axis of the object, that is, a left-right, up-down, and in-out shift, relative to the eye of the camera may further modify the viewpoint of the displayed image. For example, one image to the next in a series of images used for advertising may be displayed, such as on a vending device (machine). A person or object may change his/her/its position laterally, vertically, diagonally, backward, or forward. In addition to features described above with reference to a method of the disclosed technology, different viewpoints of the same image or scene may be exhibited on the display device when the (detected) object is at each of two opposite extremes of the plane of view of the camera, e.g., when rotating a view around a three-dimensional object.

### BRIEF DESCRIPTION OF THE DRAWINGS

FIG. 1 shows a side view of three-dimensional objects which are displayed on a two-dimensional viewing device in an embodiment of the disclosed technology.

FIG. 2A shows a top view of a camera, display device, and person at a first position in an embodiment of the disclosed technology.

FIG. 2B shows a view from camera 210 of FIG. 2A in an embodiment of the disclosed technology.

FIG. 2C shows the contents of the display device of FIG. 2A in an embodiment of the disclosed technology.

FIG. 3A shows a top view of a camera, display device, and viewer at a left position in an embodiment of the disclosed technology.

FIG. 3B shows a view from camera 210 of FIG. 3A in an embodiment of the disclosed technology.

FIG. 3C shows the contents of the display device of FIG. 3A in an embodiment of the disclosed technology.

FIG. 4A shows a top view of a camera, display device, and viewer at a right position in an embodiment of the disclosed technology.

FIG. 4B shows a view from camera 210 of FIG. 4A in an embodiment of the disclosed technology.

FIG. 4C shows the contents of the display device of FIG. 4A in an embodiment of the disclosed technology.

FIG. 5 shows the steps taken to carry out a first embodiment of a method of the disclosed technology.

FIG. 6A shows a correlation between change in lateral object position and change in rotation around a fixed point in an embodiment of the disclosed technology.

FIG. 6B shows a correlation between change in vertical object position and change in viewing height relative to a starting height in an embodiment of the disclosed technology.

FIG. 7 shows a vending device which may be used to carry out an embodiment of the disclosed technology.

FIGS. 8A through 8D show displays of a plurality of images on the device of FIG. 7 as a result of a change in detected position of an object.

FIG. 9 shows a high level block diagram of an interactive video receiving device on which embodiments of the disclosed technology may be carried out.

FIG. 10 shows a high-level block diagram of a computer that may be used to carry out the disclosed technology.

### DETAILED DESCRIPTION OF EMBODIMENTS OF THE DISCLOSED TECHNOLOGY

Embodiments of the disclosed technology comprise devices and methods of displaying images on a display (e.g., viewing screen) and changing the image based on a position of an object, such as a person, in the plane of view of a camera or other detecting device located at or near the display. A first image is exhibited on the display and a position of an object, such as a person within the view of a camera (e.g., optical, infrared, radio frequency, or other detecting device) is detected. The object may be a person (e.g. features such as silhouette or full outline/position of a person) and the person may be detected by way of a body part feature and/or face detection feature (e.g., detecting the position of a face or an eye within the view of the camera). When the object moves, the display changes (e.g., a second image is displayed) corresponding to the second position of the object in the viewing plane. The images shown may be views from different angles of a subject matter, the views or viewpoints corresponding to the position change of the object in a camera. The images shown may be a sequence in an ad display. Still further, the images shown may be disconnected (e.g., no logical connection or no viewing symmetry) from one image to another.

In a further method of changing a displayed image, a first image is displayed, a first and second position of an object in a viewing plane (e.g. x-axis view of a camera, y-axis view of a camera, z-axis view of a camera determined from a measure of size of an object, or combination thereof) is determined. When the first and second positions are above a threshold, the distance moved between the first and second position is translated into a viewpoint change and a second image is displayed corresponding to this viewpoint change. The viewpoint change, that is, the displayed image, may be translated, zoomed, rotated around a point, or any combination thereof, with respect to the first image shown. This process may be repeated with successive images.

Embodiments of the disclosed technology will become clearer in view of the description of the following figures.

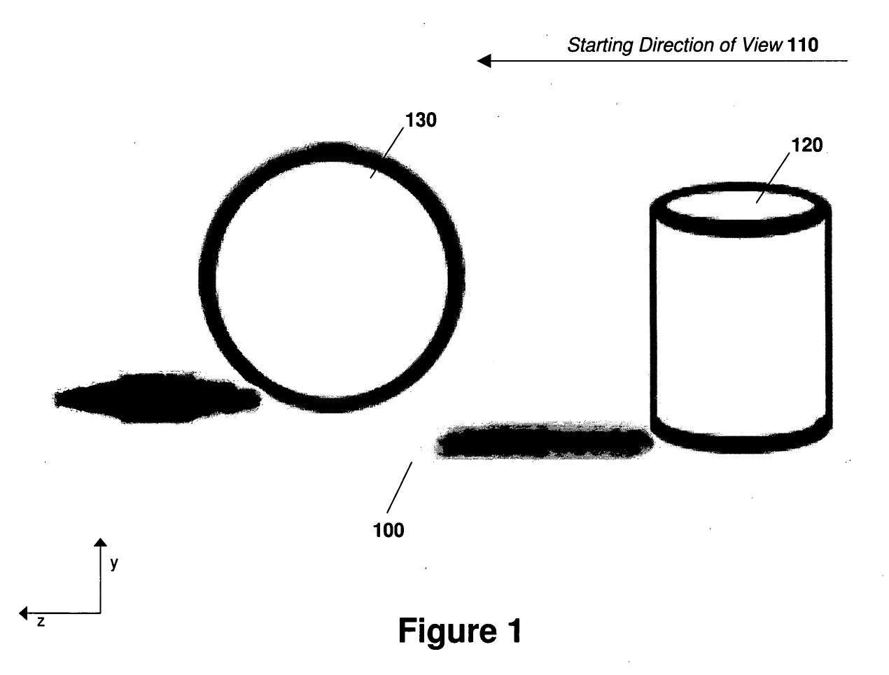

FIG. 1 shows a side view of three-dimensional objects which are displayed on a two-dimensional viewing device in an embodiment of the disclosed technology. Cylinder 120 and sphere 130 are objects positioned relative to one another within three-dimensional space. In the present example, the center cylinder 120 and sphere 130 share an x coordinate (perpendicular to the plane of the sheet on which drawing 100 lies) and y coordinate (vertical on the plane of the sheet on which drawing 100 lies). However, cylinder 120 and sphere 130 differ in z coordinate (horizontal position on the plane of the sheet on which drawing 100 lies). Thus, referring to the starting direction of view 110, looking in-line with the z axis, cylinder 120 appears in front of sphere 130. A problem arises in that with this view, the viewer cannot see sphere 130 or a large part thereof on a two-dimensional display. An application of the disclosed technology allows for the use of a plurality of two-dimensional images which are displayed in sequence based on a change in viewing position of a viewer (e.g., an object). A change in viewing position corresponds to a change in the two-dimensional image shown, the change corresponding, in embodiments of the disclosed technology, to a viewing direction of the objects.

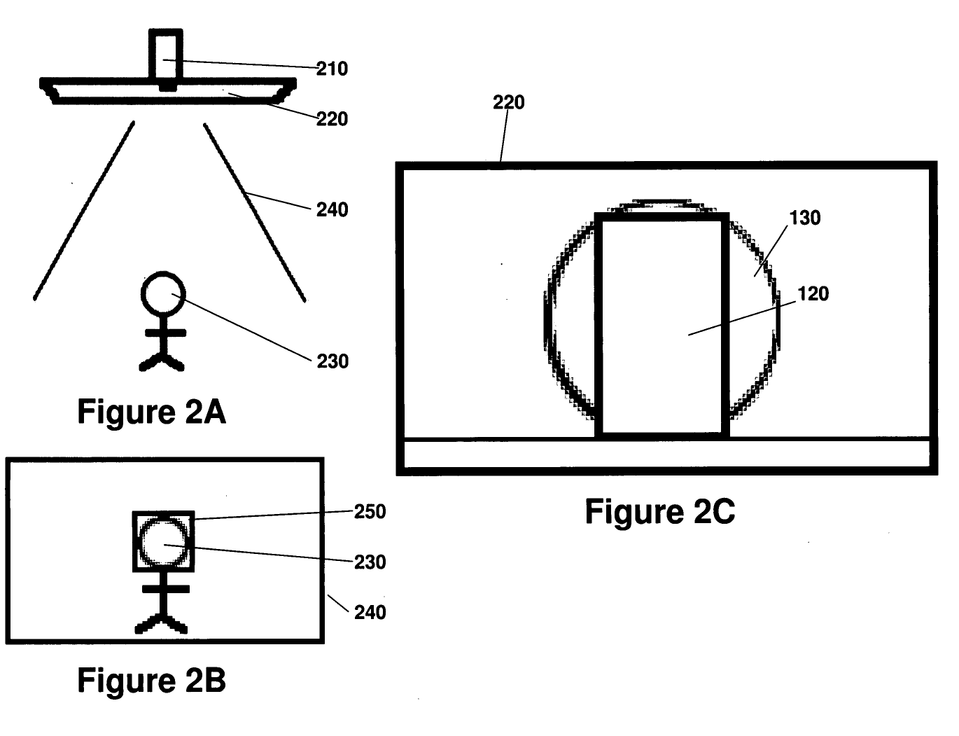

FIG. 2A shows a top view of a camera, display device, and person (e.g., object) at a first position in an embodiment of the disclosed technology. Camera 210 receives an input, such as a video input which receives video within a plane of view 240. The plane of view comprises an object 230, such as a person. The position of person 230, in an embodiment of the disclosed technology, is determined based on the detected location of the object, such as face 250 shown in the Figure and determined by face detection. The position of the face of the person is most relevant in embodiments of the disclosed technology, but a hand, leg, torso, body in general (as determined by motion, speed, color, direction, shape, or other characteristics) may be used. Still further, in embodiments of the disclosed technology eye detection is used. That is, the position of the eye or set of two eyes in the plane of view of the video is used to determine when to change a displayed image. Any type of object detection may be used in embodiments of the disclosed technology. Display 220 exhibits an image. The display may be a computer monitor, television, or substantially any device capable of exhibiting a picture image, word image, or another changeable and identifiable image.

FIG. 2B shows a view from camera 210 of FIG. 2A in an embodiment of the disclosed technology. The person 230 is within the plane of view 240. As can be seen in the figure, in this first position, the person 230 is in the center of the plane of view 240 of the camera, but it should be understood that this is by way of example, and any starting position may be used, and the displayed image may be calibrated based on a central position, edge position, or the like, depending on the specific requirements of the system (as will be described with reference to later figures).

FIG. 2C shows the contents of the display device of FIG. 2A in an embodiment of the disclosed technology. The display device 220, in this example, at the first position shows a two-dimensional view of the three-dimensional objects described in FIG. 1 along direction of view 110, that is, inline with the z axis. As a result, cylinder 120 is viewable in full and sphere 130 (not drawn to scale) is partially or fully obscured by the cylinder.

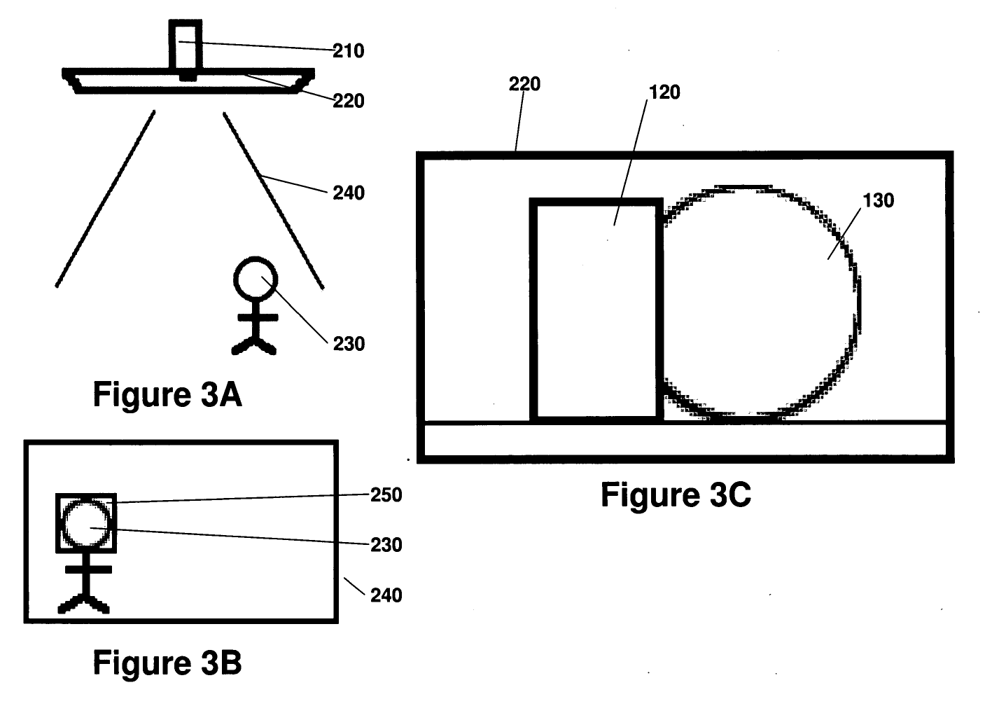

FIG. 3A shows a top view of a camera, display device, and viewer at a left position in an embodiment of the disclosed technology. FIG. 3B shows a view from camera 210 of FIG. 3A in an embodiment of the disclosed technology. The object, in this case, person 230, has moved to the right, from a first position shown in FIG. 2A to this new second position shown in FIG. 3A. The camera 210, based on object, face, eye, or other detection, recognizes the change in position of the object (in this case, lateral change of position; however, in embodiments of the disclosed technology, vertical, diagonal, near (“forward”), far (“backward”) changes or other changes in position may be used). As seen in FIG. 3B, the change in position of the person 230 results in moving to the left in the viewing plane 240.

FIG. 3C shows the contents of the display device of FIG. 3A in an embodiment of the disclosed technology. As a result of the detected move of object 230 to the left, the image is changed. As shown in this example, the image is changed to a second image, and this image is “rotated” around the an image element or a reference point located between the detected person or object and elements within or in front of in the projected scene, or located at a specific object in the projected view of the scene. The “rotation” is by way of displaying a second image of the same scene or contents of the image, but from a different vantage point such as a different position in three-dimensional space (referred to as a “viewpoint” herein after). Rotating, in embodiments of the disclosed technology, means that the viewpoint changes, but that a fixed point or focal point used to calculate and project the view in the display plane remains the same in the first and second images. Thus, the second viewpoint may be in a direction offset from the z-axis and may correspond to a distance of movement of the object 230 within the viewing plane 240, which may further comprise a calculation of an absolute distance movement of the object within the viewing plane. As such, a distance moved of an object is translated into a degree of rotation around a fixed point and projected onto the plane of the display screen, e.g. a new viewpoint.

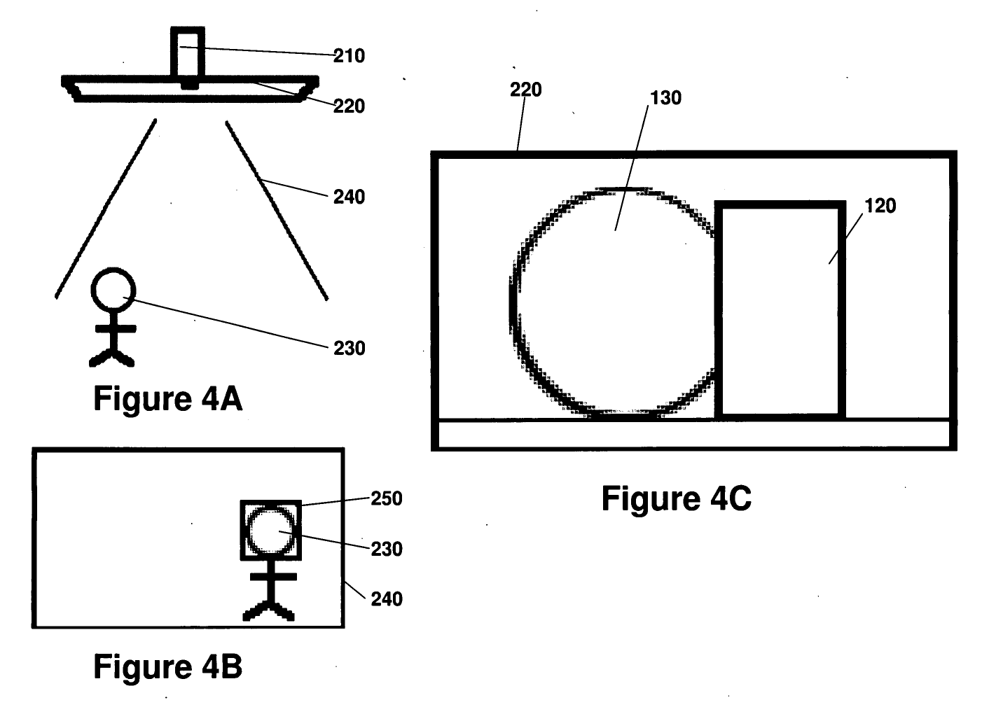

FIG. 4A shows a top view of a camera, display device, and viewer at a right position in an embodiment of the disclosed technology. FIG. 4B shows a view from camera 210 of FIG. 4A in an embodiment of the disclosed technology. FIG. 4C shows the contents of the display device of FIG. 4A in an embodiment of the disclosed technology. It should be understood that FIGS. 4A through 4C may be described just as FIGS. 3A through 3C, respectively, have been described, except that the direction of movement is reversed. Thus, object 230 moves to the left in physical space or to the right in the viewing plane 240 of the camera 210. As a result, a second image is displayed based on the new position of the object and its relationship to the displayed scene. The second image may further be displayed based on a direction and/or distance of movement. As a result, on display device 220, a depiction of sphere 130 and cylinder 120 may be displayed in the relative positions shown.

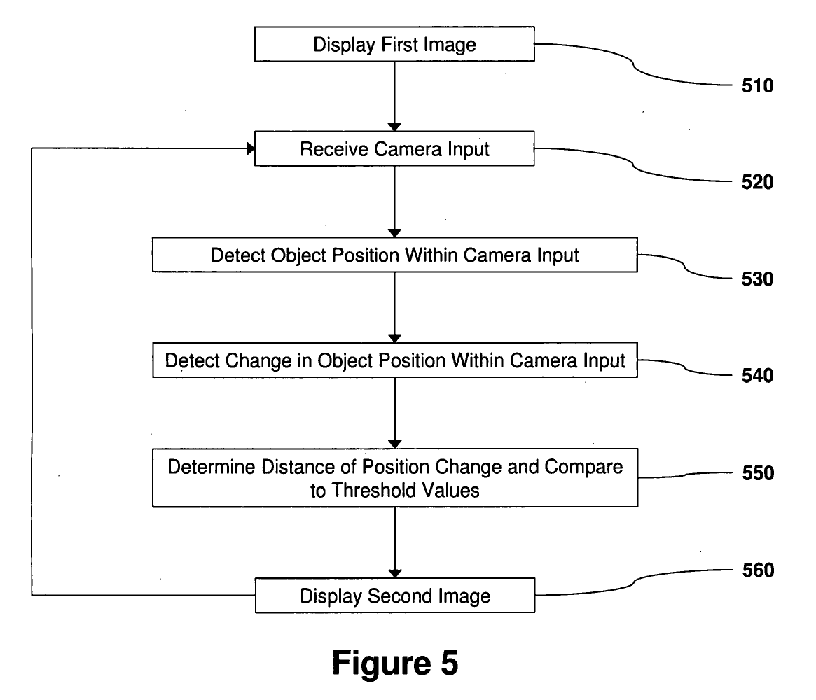

FIG. 5 shows the steps taken to carry out a first embodiment of a method of the disclosed technology. In step 510, a first image is displayed, such as on a display device as described herein above and below. In step 520, a camera input is received. This is, for example, a series of video frames received by a camera functioning in natural light, such as a computer web cam, television camera, or the like. The camera may also be an infrared camera (including an infrared sensor/motion detector), or a radio frequency sensor (e.g., radar, sonar, etc.). Based on the camera input, in step 530, the position of an object, such as the face or eye(s) of a person, is detected. Prior art methods may be used to accomplish the face or eye(s) detection. For example, the technology disclosed in U.S. Pat. No. 6,301,370 to Steffens, et al. may be used to carry out face or eye detection in embodiments of the disclosure and is hereby incorporated by reference in its entirety.

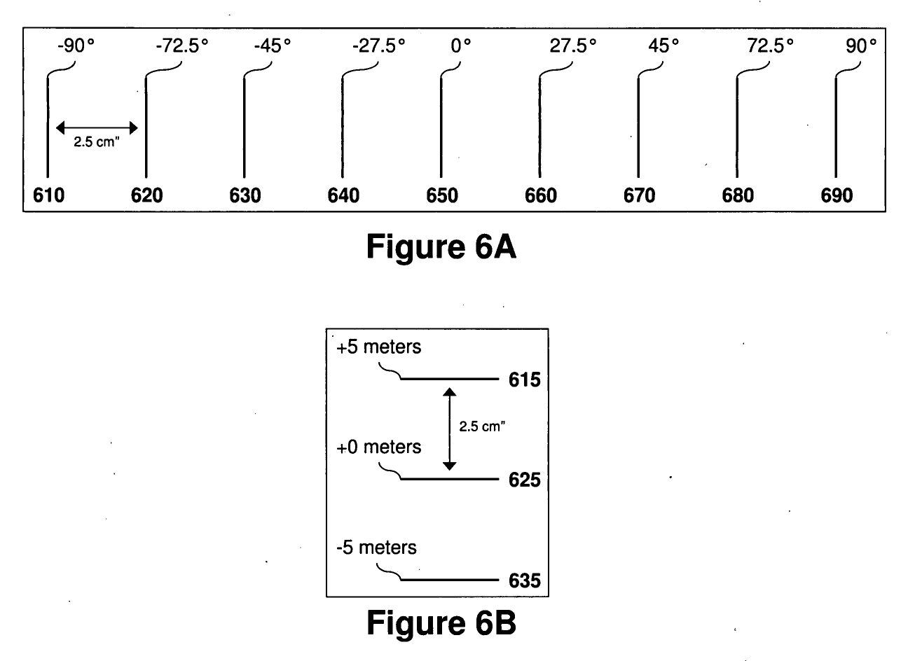

After the object position is determined, in step 540, a change in the position within the viewing plane of the camera (e.g., by analyzing inputted data received from a camera) is detected. In step 550 it is determined whether the change in position is above a threshold value, such as above an absolute distance moved (e.g., one inch), a distance moved within the viewing plane of the camera (e.g., 50 pixels), or the like. The change in position may be lateral, vertical, diagonal, or a distance from the camera change. A combination thereof is also within the scope and spirit of the disclosed technology. The distance moved versus image displayed will be discussed in more detail with reference to FIG. 6.

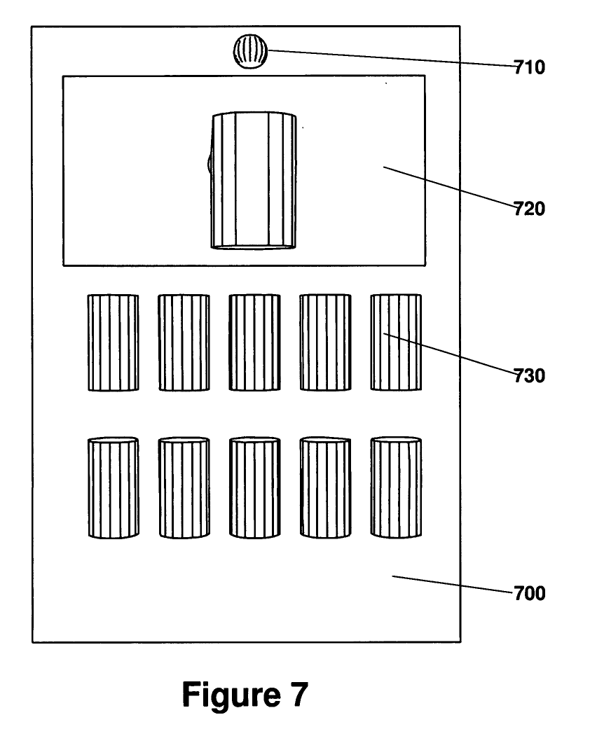

Detecting the change in position of an object in the viewing plane of the camera may be an “invasive” or “non-invasive” detection. An invasive detection is defined as a change in position of an object (including a person) within the viewing plane of the camera for purposes of intentionally changing a displayed image on a display device such as display device 220. A non-invasive detection is defined as a change in position of an object (including a person) within the viewing plane of the camera for a purpose other than to change a displayed image on a display device, such as display device 220. Thus, the non-invasive detection causes an unintentional change of a displayed image. An example of an invasive change is a person viewing the display device 220 in FIG. 2 and moving his or her head to the right or up to try and look around cylinder 120. An example of a non-invasive change is a person walking past the plane of view of a camera, and an image on display device 220 changing without the person walking intending for this change to happen. Further examples of non-invasive detection will be provided in FIG. 7 below.

If the change in distance is above a predefined threshold (e.g. a set threshold distance as determined before step 540 is carried out), then step 560 is carried out, whereby a second image is displayed (e.g., the image displayed on display device 220 is changed). Meanwhile, step 520 continues to be carried out and steps 530 through 560 may be repeated with third, fourth, fifth, and so forth, images. This may happen in quick succession, and/or a predefined pause time may be defined to ensure the images do not change too quickly, such as for a display ad with multiple images.

FIG. 6A shows a correlation between change in lateral object position and change in rotation around a fixed point in an embodiment of the disclosed technology. FIG. 6B shows a correlation between change in vertical object position and change in viewing height relative to a starting height in an embodiment of the disclosed technology. It should be understood, of course, that FIGS. 6A and 6B show only two of many examples which are within the scope of the disclosed technology. Any shift in position of an object (e.g., object or person 230 of FIG. 2) may correspond to a degree of rotation, height change, perspective change, zoom amount, and so forth of a displayed image.

Referring to FIG. 6A specifically and the figures in general, object positions 610 through 690 (in increments of 10) are 2.5 cm spaced-apart threshold positions of an object within a lateral viewing plane of a camera. For example, when the disclosed technology is activated, the position of a detected object (e.g., a face of a person) may be centered near or at position 650. When the detected object crosses the threshold position 660, then a second image is displayed which is rotated around a point or an object by a distance of +27.5 degrees. In this example, moving the detected object a total of 25 cm to the left or right, from one extreme to the other on the lateral plane of view of the camera, results in a complete 180 degree rotation around a fixed point, e.g., to view both sides of a three-dimensional object by moving one's head or eyes to the left or right. From the center of the plane of view to the extreme right is +90 degrees, and from the center of the plane of view to the extreme left is −90 degrees, in this example.

In a further example, the rotation of the image displayed at position 610 and 690 may be a −180 and +180 rotated viewpoint with respect to a center or first image at position 650. This type of rotation is also possible within the framework of the disclosed technology, particularly when the projected views are artificially generated. Here, the rotation about a fixed point (which includes a fixed object in embodiments of the disclosed technology) has the same net result—e.g. a 180 degree rotated view in either direction yields the same image displayed in either case corresponding to an extreme movement of the detected object (e.g. object 230) in any direction along the viewing plane of a camera. FIGS. 3A through 3C may, for example, correspond to when an object is detected at position 610, and FIGS. 4A through 4C may, for example, correspond to when an object is detected at position 690. FIGS. 2A through 2C, therefore, would correspond to when an object is detected at position 650. It should also be understood that the first image displayed may always be the same first image at the time of object position detection or may be based on an absolute position of the detected object within the viewing plane of the camera.

Referring now to FIG. 6B, specifically, and the figures in general, based on a detected change along a vertical plane of view of the camera, a change in vertical rotation around a point or object in the display scene is shown on the display. In the example of FIG. 6B, at a first height 625 within a vertical viewing plane of a camera, a first image is displayed. When the detected object moves upwards 2.5 cm to height 615, then a second image is displayed, except that this second image is rotated downward around a point or object in the displayed image, changing the viewpoint to one taken from above, corresponding to a new viewing height 5 m above the height of the prior viewpoint and first image. When the detected object moves downwards (from the starting height 625) 2.5 cm to height 635, then the second image displayed rotates upwards, showing a viewpoint taken from below, corresponding to a new viewing height of −5 m.

Further correlations of detected position to displayed image should be apparent based on the descriptions of FIGS. 6A and 6B and are within the scope and spirit of the disclosed technology. It should also be understood that more than one correlation may take place. For example, upon detecting an object moving upwards 5 cm, zooming in 1.5×, and moving to the left 1 meter, a related change may take place in the second displayed image. Moving upwards an additional 5 cm would result in a corresponding and proportional transformation from the second to the third displayed image.

FIG. 7 shows a vending device which may be used to carry out an embodiment of the disclosed technology. The vending device 700 (which may be a vending machine, as is known in the art) sells products to a purchaser in exchange for payment for a product (e.g., by inserting money or credit card). The vending device is one of many devices which may be used to carry out embodiments of the disclosed technology and is an example of a device which can be used in a non-invasive manner, e.g., without intent of a passerby to manipulate the display screen 720. A camera 710 is positioned somewhere on the device, such as above or near the display screen 720. Buttons 730 are used to select a product to be sold. Other elements of a vending device, such as coin and paper currency inputs, vending outlet, and so forth, are not shown, for the sake of simplicity.

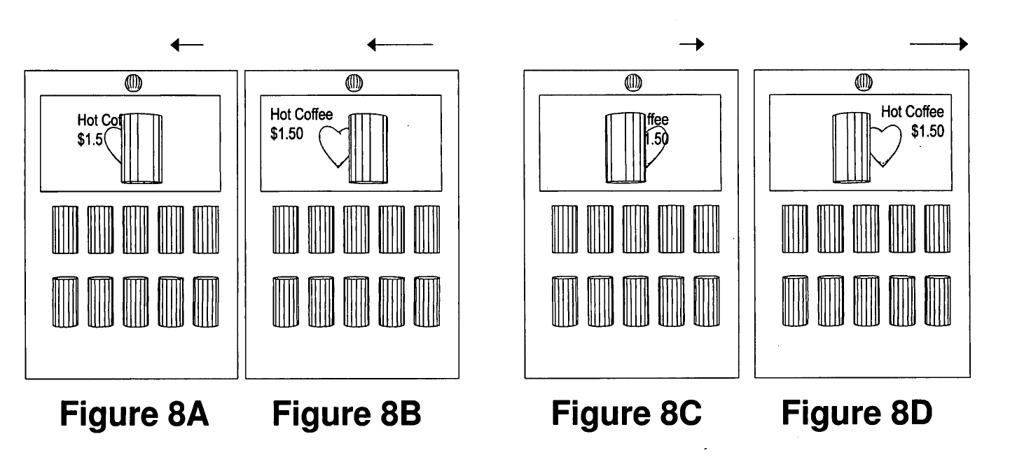

FIGS. 8A through 8D show displays of a plurality of images on the device of FIG. 7 as a result of a change in detected position of an object. The detected position may be obtained by the camera 710 by way of any of the methods described herein above. At a first detected position, e.g., the first time an object is detected in the viewing plane of camera 710, the image shown on display device 720 is a cup, perhaps with a logo. Referring now to a portion of FIG. 6A, ignoring the scale and degree measurements in the figure for the sake of this example, the detected position will be defined as being at position 680, where the plane of view of the camera extends from 610 to 690. This may be a person walking from the right side of the vending machine past the vending machine. As the person (object) approaches position 660, an image like that shown in FIG. 8A is displayed on display device 720. After the person passes the eye of the camera, e.g., after about position 640, an image on displayed device 720 may be displayed like that shown in FIG. 8B. Similarly, a person walking closer to the vending device 700 may be detected as a closer object and the display may rotate around a fixed point, in this case, the cup, in order to gradually display the heart and message hidden behind.

Thus, as a person is walking by or up to the vending device 700, a heart (see the figure) may slowly appear on the screen as the person moves with an advertisement, or the like. Dimming may occur of the heart or other portion or all of the display between one image and the next to make for a smooth transaction, or the heart may appear to move from one position to another, with each image shown by providing a sequence of very close images (e.g., animation). Similarly, text or other indicia may be displayed as an object moves through (changes position) in reference to an eye of a camera, and it should be understood that the drawing shown in the advertisement is by way of example and is not intended to be limiting.

FIGS. 8C and 8D may be what is shown in the example described immediately above where an object moves to the right, relative to the first detected position of the object (to the left from the point of view of the camera). In this manner, the heart image moves with a person (object) as it walks and attracts attention, so as to draw a person in to see the vending device 700, so that he/she may be more likely to make a purchase.

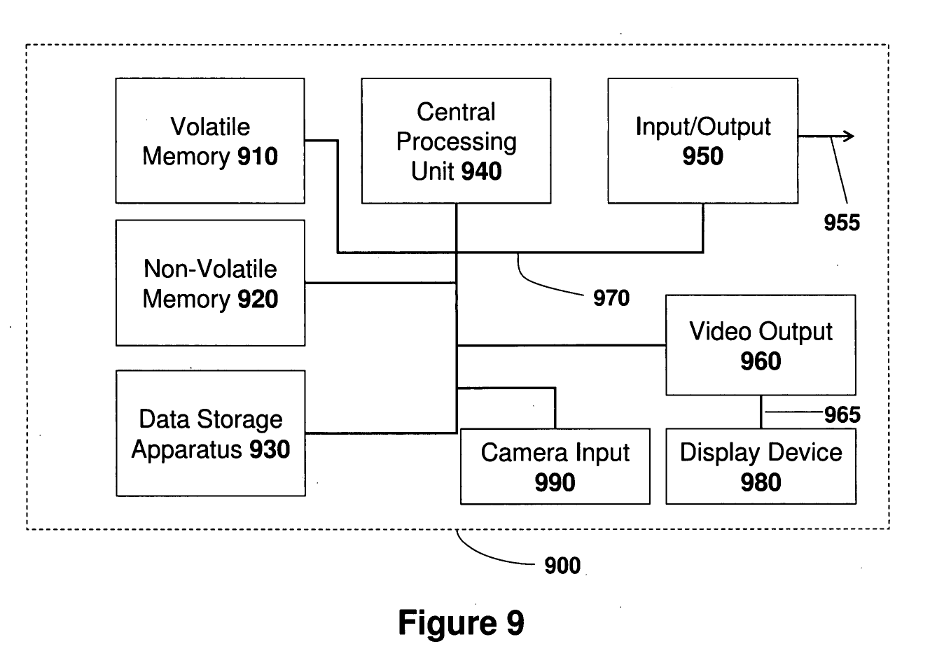

FIG. 9 shows a high level block diagram of a specialized image input and display device on which embodiments of the disclosed technology may be carried out. The device may comprise some or all of the high level elements shown in FIG. 9 and may comprise further devices or be part of a larger device. Data bus 970 transports data between the numbered elements shown in device 900. Central processing unit 940 receives and processes instructions such as code. Volatile memory 910 and non-volatile memory 920 store data for processing by the central processing unit 940.

The data storage apparatus 930 may be magnetic media (e.g., hard disk, video cassette), optical media (e.g., Blu-Ray or DVD) or another type of storage mechanism known in the art. The data storage apparatus 930 or the non-volatile memory 920 stores data which is sent via bus 970 to the video output 960. The video output may be a liquid crystal display, cathode ray tube, or series of light-emitting diodes. Any known display may be used.

A data or video signal is received from a camera input 990 (e.g., a video camera, one or a plurality of motion sensors, etc.). The displayed image, as described above, is outputted via a video output 960, that is, a transmitter or video relay device which transmits video to another device, such as a television screen, monitor, or other display device 980 via cable or data bus 965. The video output 960 may also be an output over a packet-switched network 965 such as the internet, where it is received and interpreted as video data by a recipient device 980.

An input/output device 950, such as buttons on the interactive device itself, an infrared signal receiver for use with a remote control, or a network input/output for control via a local or wide area network, receives and/or sends a signal via data pathway 855 (e.g., infrared signal, signal over copper or fiber cable, wireless network, etc. The input/output device, in embodiments of the disclosed technology, receives input from a user, such as which image to display and how to interact with a detected object.

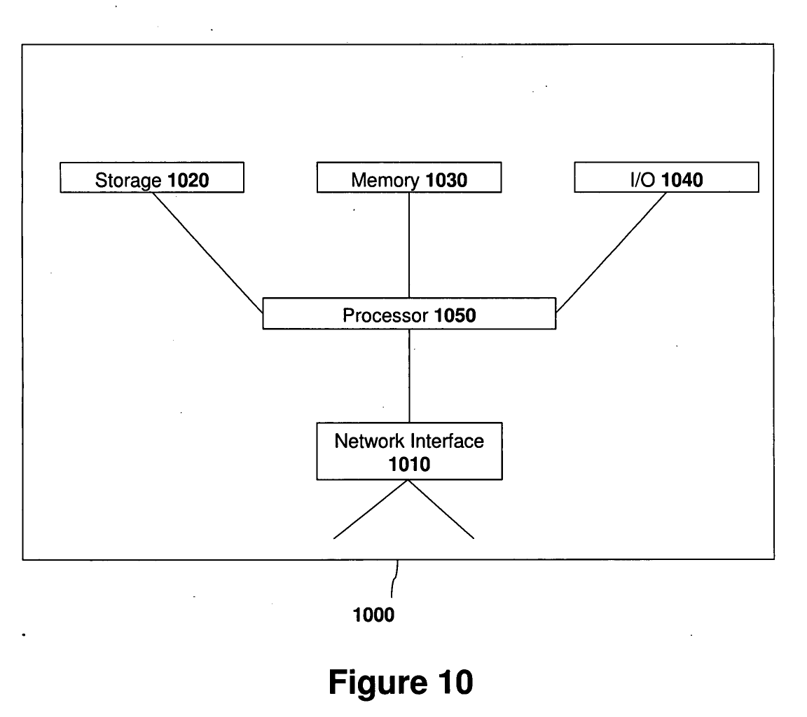

FIG. 10 shows a high-level block diagram of a computer that may be used to carry out the disclosed technology. Computer 1000 contains a processor 1004 that controls the overall operation of the computer by executing computer program instructions which define such operation. The computer program instructions may be stored in a storage device 1008 (e.g., magnetic disk, database) and loaded into memory 1012 when execution of the computer program instructions is desired. Thus, the computer operation will be defined by computer program instructions stored in memory 1012 and/or storage 1008, and the computer will be controlled by processor 1004 executing the computer program instructions. Computer 1000 also includes one or a plurality of input network interfaces for communicating with other devices via a network (e.g., the internet). Computer 1000 also includes one or more output network interfaces 1016 for communicating with other devices. Computer 1000 also includes input/output 1024, representing devices which allow for user interaction with the computer 1000 (e.g., display, keyboard, mouse, speakers, buttons, etc.).

One skilled in the art will recognize that an implementation of an actual computer will contain other components as well, and that FIGS. 9 and 10 are high level representations of some of the components of a computer or switch and are for illustrative purposes. It should also be understood by one skilled in the art that the method and devices depicted or described may be implemented on a device such as is shown in FIGS. 9 and 10.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

We claim:

1. A method of changing a displayed image, said method comprising the steps of:
displaying a first said image on a display device;
detecting with a camera a first and second position of an object in a viewing plane of said camera wherein said first and second positions are spaced apart a predefined threshold distance;
translating the distance moved between said first and second position into a viewpoint change; and
displaying a second image comprising said viewpoint change.

2. The method of claim 1, wherein said viewpoint change is selected from the group consisting of zoomed, rotated, translated, and a combination thereof.

3. The method of claim 1, further comprising detecting a plurality of additional positions of said object, each said additional positions comprising a distance from a previous position above said predefined threshold, and changing a displayed image for each position of said additional positions.

4. The method of claim 1, wherein said object is a person and said detecting comprises detecting a position of a feature of a person.

5. The method of claim 4, wherein said feature is a face.

6. The method of claim 1, wherein said method is non-invasive.

7. The method of claim 3, wherein each said displayed image comprises a viewpoint change with respect to a fixed point.

8. The method of claim 2, wherein said distance moved comprises a distance moved along at least two of the x, y, and z axes.

9. The method of claim 7, wherein changing a position of said object across a plane of view of said camera results in a 180 degree of rotation around said fixed point or object.

10. The method of claim 1, wherein said images comprise advertising.

11. A device comprising:
a display device outputting a displayed image;
a camera inputting data in a plane of view of said camera; and
a processor determining a location of an object in said plane of view;
wherein upon said determined location of said object changing position greater than a threshold, a change in viewpoint corresponding to a distance of said changing position is determined and said display device outputs a second displayed image based on said change in viewpoint.

12. The device of claim 11, wherein said displayed images are advertising.

13. The device of claim 12, wherein said device is a vending device.

14. The method of claim 11, wherein said viewpoint change is selected from the group consisting of zoomed, rotated, translated, and a combination thereof.

15. The device of claim 11, wherein said object is a person and said detecting comprises detecting a position of a feature of a person.

16. The method of claim 15, wherein said feature is a face.

17. The method of claim 11, wherein said method is non-invasive.

18. The method of claim 11, wherein each said distance of said position change is a change along at least two of the x, y, and z axis.

19. The method of claim 11, wherein a second outputted image, relative to a first outputted image, comprises a said viewpoint rotated around a fixed point.

20. The method of claim 19, wherein the same image is exhibited on said display device when said object is at each of two opposite extremes of said plane of view of said camera.
